(19) United States
(12) Patent Application Publication
(10) Pub. No.: US 2009/0046585 A1
(43) Pub. Date: Feb. 19, 2009

(54) Determining Communications Latency for Transmissions Between Nodes in a Data Communications Network

(76) Inventor: Ahmad A. Faraj, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/838,969

(22) Filed: Aug. 15, 2007

(51) Int. Cl. G08C 15/00

(52) U.S. Cl. 370/236

(57) ABSTRACT

Methods, systems, and apparatus are disclosed for determining communications latency for transmissions between nodes in a data communications network that include: preparing, by an origin node, to receive an acknowledgement message from a target node, the acknowledgement message indicating that the target node is ready to receive a test message from the origin node; receiving, by the origin node from the target node, the acknowledgement message; sending, by the origin node to the target node in response to receiving the acknowledgement message, the test message; preparing, by the origin node, to receive an echo message from the target node; receiving, by the origin node from the target node, the echo message; and determining, by the origin node, a round-trip communications latency between the origin node and the target node in dependence upon the sending of the test message and the receiving of the echo message.

### STATEMENT REGARDING FEDERALLY SPONSORED RESEARCH OR DEVELOPMENT

This invention was made with Government support under Contract No. B554331 awarded by the Department of Energy. The Government has certain rights in this invention.

### BACKGROUND OF THE INVENTION

1. Field of the Invention

The field of the invention is data processing, or, more specifically, methods, systems, and products for determining communications latency for transmissions between nodes in a data communications network.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Parallel computing is an area of computer technology that has experienced advances. Parallel computing is the simultaneous execution of the same task (split up and specially adapted) on multiple processors in order to obtain results faster. Parallel computing is based on the fact that the process of solving a problem usually can be divided into smaller tasks, which may be carried out simultaneously with some coordination.

Parallel computers execute parallel algorithms. A parallel algorithm can be split up to be executed a piece at a time on many different processing devices, and then put back together again at the end to get a data processing result. Some algorithms are easy to divide up into pieces. Splitting up the job of checking all of the numbers from one to a hundred thousand to see which are primes could be done, for example, by assigning a subset of the numbers to each available processor, and then putting the list of positive results back together. In this specification, the multiple processing devices that execute the individual pieces of a parallel program are referred to as ‘compute nodes.’ A parallel computer is composed of compute nodes and other processing nodes as well, including, for example, input/output (‘I/O’) nodes, and service nodes.

Parallel algorithms are valuable because it is faster to perform some kinds of large computing tasks via a parallel algorithm than it is via a serial (non-parallel) algorithm, because of the way modern processors work. It is far more difficult to construct a computer with a single fast processor than one with many slow processors with the same throughput. There are also certain theoretical limits to the potential speed of serial processors. On the other hand, every parallel algorithm has a serial part and so parallel algorithms have a saturation point. After that point adding more processors does not yield any more throughput but only increases the overhead and cost.

Parallel algorithms are designed also to optimize one more resource the data communications requirements among the nodes of a parallel computer. There are two ways parallel processors communicate, shared memory or message passing. Shared memory processing needs additional locking for the data and imposes the overhead of additional processor and bus cycles and also serializes some portion of the algorithm.

Message passing processing uses high-speed data communications networks and message buffers, but this communication adds transfer overhead on the data communications networks as well as additional memory needed for message buffers and latency in the data communications among nodes. Designs of parallel computers use specially designed data communications links so that the communication overhead will be small but it is the parallel algorithm that decides the volume of the traffic.

Many data communications network architectures are used for message passing among nodes in parallel computers. Compute nodes may be organized in a network as a ‘torus’ or ‘mesh,’ for example. Also, compute nodes may be organized in a network as a tree. A torus network connects the nodes in a three-dimensional mesh with wrap around links. Every node is connected to its six neighbors through this torus network, and each node is addressed by its x, y, z coordinate in the mesh. In a tree network, the nodes typically are connected into a binary tree: each node has a parent, and two children (although some nodes may only have zero children or one child, depending on the hardware configuration). In computers that use a torus and a tree network, the two networks typically are implemented independently of one another, with separate routing circuits, separate physical links, and separate message buffers.

A torus network generally supports point-to-point communications. A tree network, however, typically only supports communications where data from one compute node migrates through tiers of the tree network to a root compute node or where data is multicast from the root to all of the other compute nodes in the tree network. In such a manner, the tree network lends itself to collective operations such as, for example, reduction operations or broadcast operations. The tree network, however, does not lend itself to and is typically inefficient for point-to-point operations.

As mentioned above, the compute nodes of a parallel computer may use message passing operations to share data through such data communications networks described above. A common measure of the performance for these message passing operations is the one-way communications latency for transmissions between two compute nodes. In the current art, however, accurately determining the one-way communications latency for transmissions is often difficult because a global clock may be unavailable to the compute nodes in the system. In systems that include a global clock, an accurate determination of the one-way communications latency for transmissions is often still difficult because the global clock is not tightly synchronized among all the compute nodes of the parallel computer. Attempts to solve the synchronization problem have included using a barrier operation in the algorithm that determines the one-way communications latency for transmissions. A barrier operation is an operation that prevents any single compute node in an operational group from processing beyond a particular point in a parallel algorithm until all of the other compute nodes reach the same point in the algorithm. Unfortunately, many implementations of the barrier operation do not ensure the degree of synchronization often required to accurately determine the one-way communications latency for transmissions among compute nodes. As such, readers will appreciate that room for improvement exists in determining communications latency for transmissions between nodes in a data communications network.

### SUMMARY OF THE INVENTION

Methods, systems, and products are disclosed for determining communications latency for transmissions between nodes in a data communications network that include: preparing, by an origin node, to receive an acknowledgement message from a target node, the acknowledgement message indicating that the target node is ready to receive a test message from the origin node; receiving, by the origin node from the target node, the acknowledgement message; sending, by the origin node to the target node in response to receiving the acknowledgement message, the test message; preparing, by the origin node, to receive an echo message from the target node, the echo message indicating that the target node received the test message; receiving, by the origin node from the target node, the echo message; and determining, by the origin node, a round-trip communications latency between the origin node and the target node in dependence upon the sending of the test message and the receiving of the echo message.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an exemplary parallel computer for determining communications latency for transmissions between nodes in a data communications network according to embodiments of the present invention.

FIG. 2 sets forth a block diagram of an exemplary compute node useful in a parallel computer capable of determining communications latency for transmissions between nodes in a data communications network according to embodiments of the present invention.

FIG. 3A illustrates an exemplary Point To Point Adapter useful in a parallel computer capable of determining communications latency for transmissions between nodes in a data communications network according to embodiments of the present invention.

FIG. 3B illustrates an exemplary Global Combining Network Adapter useful in a parallel computer capable of determining communications latency for transmissions between nodes in a data communications network according to embodiments of the present invention.

FIG. 4 sets forth a line drawing illustrating an exemplary data communications network optimized for point to point operations useful in a parallel computer capable of determining communications latency for transmissions between nodes in a data communications network according to embodiments of the present invention.

FIG. 5 sets forth a line drawing illustrating an exemplary data communications network optimized for collective operations useful in a parallel computer capable of determining communications latency for transmissions between nodes in a data communications network according to embodiments of the present invention.

FIG. 6 sets forth a flow chart illustrating an exemplary method for determining communications latency for transmissions between nodes in a data communications network according to the present invention.

FIG. 7A sets forth an exemplary listing of pseudo-code that describes determining communications latency for transmissions between nodes in a data communications network according to embodiments of the present invention.

FIG. 7B sets forth a further exemplary listing of pseudo-code that describes determining communications latency for transmissions between nodes in a data communications network according to embodiments of the present invention.

FIG. 8 sets forth a call sequence diagram illustrating an exemplary call sequence for determining communications latency for transmissions between nodes in a data communications network according to embodiments of the present invention.

### DETAILED DESCRIPTION OF EXEMPLARY EMBODIMENTS

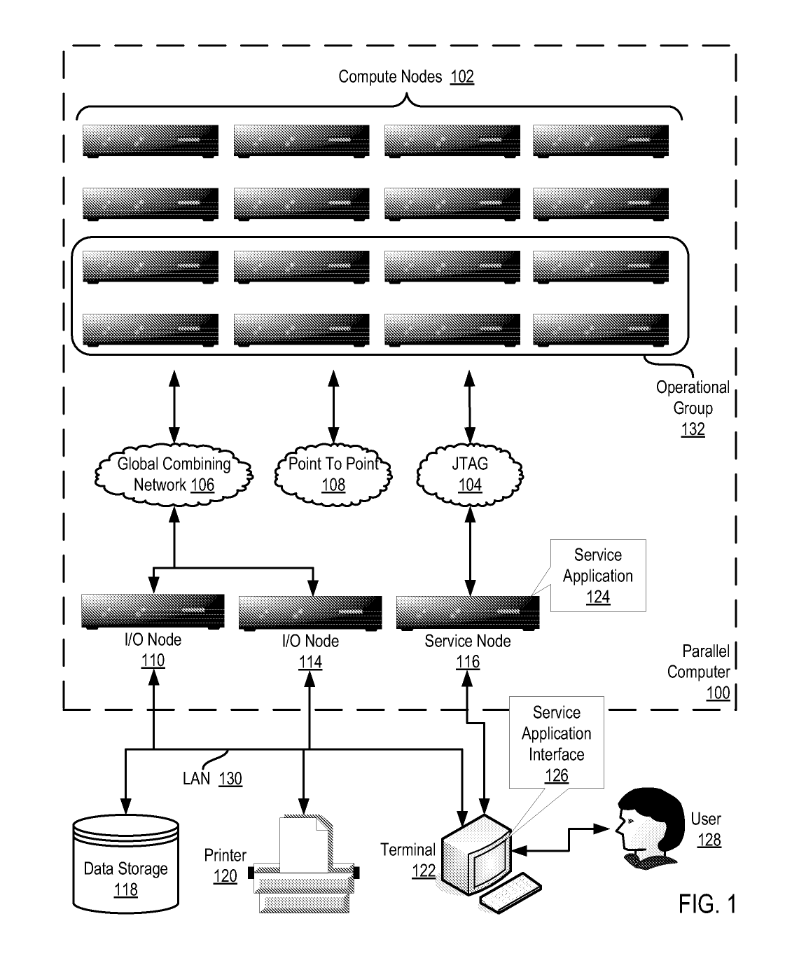

Exemplary methods, systems, and computer program products for determining communications latency for transmissions between nodes in a data communications network according to embodiments of the present invention are described with reference to the accompanying drawings, beginning with FIG. 1. FIG. 1 illustrates an exemplary parallel computer for determining communications latency for transmissions between nodes in a data communications network according to embodiments of the present invention. The system of FIG. 1 includes a parallel computer (100), non-volatile memory for the computer in the form of data storage device (118), an output device for the computer in the form of printer (120), and an input/output device for the computer in the form of computer terminal (122). Parallel computer (100) in the example of FIG. 1 includes a plurality of compute nodes (102).

The compute nodes (102) are coupled for data communications by several independent data communications networks including a Joint Test Action Group (‘JTAG’) network (104), a global combining network (106) which is optimized for collective operations, and a torus network (108) which is optimized point to point operations. The global combining network (106) is a data communications network that includes data communications links connected to the compute nodes so as to organize the compute nodes as a tree. Each data communications network is implemented with data communications links among the compute nodes (102). The data communications links provide data communications for parallel operations among the compute nodes of the parallel computer. The links between compute nodes are bi-directional links that are typically implemented using two separate directional data communications paths.

In addition, the compute nodes (102) of parallel computer are organized into at least one operational group (132) of compute nodes for collective parallel operations on parallel computer (100). An operational group of compute nodes is the set of compute nodes upon which a collective parallel operation executes. Collective operations are implemented with data communications among the compute nodes of an operational group. Collective operations are those functions that involve all the compute nodes of an operational group. A collective operation is an operation, a message-passing computer program instruction that is executed simultaneously, that is, at approximately the same time, by all the compute nodes in an operational group of compute nodes. Such an operational group may include all the compute nodes in a parallel computer (100) or a subset all the compute nodes. Collective operations are often built around point to point operations. A collective operation requires that all processes on all compute nodes within an operational group call the same collective operation with matching arguments. A ‘broadcast’ is an example of a collective operation for moving data among compute nodes of an operational group. A ‘reduce’ operation is an example of a collective operation that executes arithmetic or logical functions on data distributed among the compute nodes of an operational group. An operational group may be implemented as, for example, an MPI ‘communicator.’

‘MPI’ refers to ‘Message Passing Interface,’ a prior art parallel communications library, a module of computer program instructions for data communications on parallel computers. Examples of prior-art parallel communications libraries that may be improved for use with systems according to embodiments of the present invention include MPI and the ‘Parallel Virtual Machine’ (‘PVM’) library. PVM was developed by the University of Tennessee, The Oak Ridge National Laboratory, and Emory University. MPI is promulgated by the MPI Forum, an open group with representatives from many organizations that define and maintain the MPI standard. MPI at the time of this writing is a de facto standard for communication among compute nodes running a parallel program on a distributed memory parallel computer. This specification sometimes uses MPI terminology for ease of explanation, although the use of MPI as such is not a requirement or limitation of the present invention.

Some collective operations have a single originating or receiving process running on a particular compute node in an operational group. For example, in a ‘broadcast’ collective operation, the process on the compute node that distributes the data to all the other compute nodes is an originating process. In a ‘gather’ operation, for example, the process on the compute node that received all the data from the other compute nodes is a receiving process. The compute node on which such an originating or receiving process runs is referred to as a logical root.

Most collective operations are variations or combinations of four basic operations: broadcast, gather, scatter, and reduce. The interfaces for these collective operations are defined in the MPI standards promulgated by the MPI Forum. Algorithms for executing collective operations, however, are not defined in the MPI standards. In a broadcast operation, all processes specify the same root process, whose buffer contents will be sent. Processes other than the root specify receive buffers. After the operation, all buffers contain the message from the root process.

In a scatter operation, the logical root divides data on the root into segments and distributes a different segment to each compute node in the operational group. In scatter operation, all processes typically specify the same receive count. The send arguments are only significant to the root process, whose buffer actually contains sendcount *N elements of a given data type, where N is the number of processes in the given group of compute nodes. The send buffer is divided and dispersed to all processes (including the process on the logical root). Each compute node is assigned a sequential identifier termed a ‘rank.’ After the operation, the root has sent sendcount data elements to each process in increasing rank order. Rank 0 receives the first sendcount data elements from the send buffer. Rank 1 receives the second sendcount data elements from the send buffer, and so on.

A gather operation is a many-to-one collective operation that is a complete reverse of the description of the scatter operation. That is, a gather is a many-to-one collective operation in which elements of a datatype are gathered from the ranked compute nodes into a receive buffer in a root node.

A reduce operation is also a many-to-one collective operation that includes an arithmetic or logical function performed on two data elements. All processes specify the same ‘count’ and the same arithmetic or logical function. After the reduction, all processes have sent count data elements from computer node send buffers to the root process. In a reduction operation, data elements from corresponding send buffer locations are combined pair-wise by arithmetic or logical operations to yield a single corresponding element in the root process's receive buffer. Application specific reduction operations can be defined at runtime. Parallel communications libraries may support predefined operations. MPI, for example, provides the following pre-defined reduction operations:

| | |
|---|---|
| MPI_MAX | maximum |
| MPI_MIN | minimum |
| MPI_SUM | sum |
| MPI_PROD | product |
| MPI_LAND | logical and |
| MPI_BAND | bitwise and |
| MPI_LOR | logical or |
| MPI_BOR | bitwise or |
| MPI_LXOR | logical exclusive or |
| MPI_BXOR | bitwise exclusive or |

In addition to compute nodes, the parallel computer (100) includes input/output (‘I/O’) nodes (110, 114) coupled to compute nodes (102) through the global combining network (106). The compute nodes in the parallel computer (100) are partitioned into processing sets such that each compute node in a processing set is connected for data communications to the same I/O node. Each processing set, therefore, is composed of one I/O node and a subset of compute nodes (102). The ratio between the number of compute nodes to the number of I/O nodes in the entire system typically depends on the hardware configuration for the parallel computer. For example, in some configurations, each processing set may be composed of eight compute nodes and one I/O node. In some other configurations, each processing set may be composed of sixty-four compute nodes and one I/O node. Such example are for explanation only, however, and not for limitation. Each I/O nodes provide I/O services between compute nodes (102) of its processing set and a set of I/O devices. In the example of FIG. 1, the I/O nodes (110, 114) are connected for data communications I/O devices (118, 120, 122) through local area network (‘LAN’) (130) implemented using high-speed Ethernet.

The parallel computer (100) of FIG. 1 also includes a service node (116) coupled to the compute nodes through one of the networks (104). Service node (116) provides services common to pluralities of compute nodes, administering the configuration of compute nodes, loading programs into the compute nodes, starting program execution on the compute nodes, retrieving results of program operations on the computer nodes, and so on. Service node (116) runs a service application (124) and communicates with users (128) through a service application interface (126) that runs on computer terminal (122).

As described in more detail below in this specification, the parallel computer (100) of FIG. 1 operates generally for determining communications latency for transmissions between nodes in a data communications network according to embodiments of the present invention. Communications latency is the time required for a message to move through a network. The parallel computer (100) of FIG. 1 operates generally for determining communications latency for transmissions between nodes in a data communications network according to embodiments of the present invention by: preparing, by an origin node, to receive an acknowledgement message from a target node, the acknowledgement message indicating that the target node is ready to receive a test message from the origin node; receiving, by the origin node from the target node, the acknowledgement message; sending, by the origin node to the target node in response to receiving the acknowledgement message, the test message; preparing, by the origin node, to receive an echo message from the target node, the echo message indicating that the target node received the test message; receiving, by the origin node from the target node, the echo message; and determining, by the origin node, the round-trip communications latency between the origin node and the target node in dependence upon the sending of the test message and the receiving of the echo message.

From the perspective of the target node, the parallel computer (100) of FIG. 1 may also operate generally for determining communications latency for transmissions between nodes in a data communications network according to embodiments of the present invention by: preparing, by the target node, to receive the test message from an origin node; sending, by the target node to the origin node, the acknowledgement message in response to preparing to receive the test message; receiving, by the target node from the origin node, the test message in response to sending the acknowledgement message; and sending, by the target node to the origin node in response to receiving the test message, the echo message.

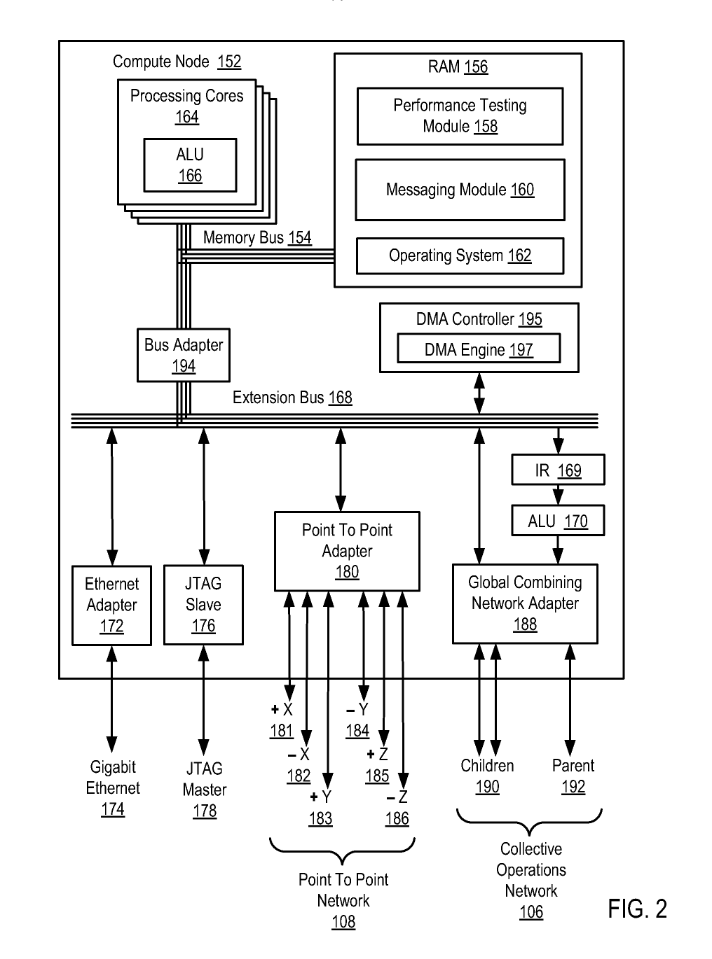

The arrangement of nodes, networks, and I/O devices making up the exemplary system illustrated in FIG. 1 are for explanation only, not for limitation of the present invention. Data processing systems capable of determining communications latency for transmissions between nodes in a data communications network according to embodiments of the present invention may include additional nodes, networks, devices, and architectures, not shown in FIG. 1, as will occur to those of skill in the art. Although the parallel computer (100) in the example of FIG. 1 includes sixteen compute nodes (102), readers will note that parallel computers capable of determining when a set of compute nodes participating in a barrier operation are ready to exit the barrier operation according to embodiments of the present invention may include any number of compute nodes. In addition to Ethernet and JTAG, networks in such data processing systems may support many data communications protocols including for example TCP (Transmission Control Protocol), IP (Internet Protocol), and others as will occur to those of skill in the art. Various embodiments of the present invention may be implemented on a variety of hardware platforms in addition to those illustrated in FIG. 1. Determining communications latency for transmissions between nodes in a data communications network according to embodiments of the present invention may be generally implemented on a parallel computer that includes a plurality of compute nodes. In fact, such computers may include thousands of such compute nodes. Each compute node is in turn itself a kind of computer composed of one or more computer processors (or processing cores), its own computer memory, and its own input/output adapters. For further explanation, therefore, FIG. 2 sets forth a block diagram of an exemplary compute node useful in a parallel computer capable of determining communications latency for transmissions between nodes in a data communications network according to embodiments of the present invention. The compute node (152) of FIG. 2 includes one or more processing cores (164) as well as random access memory (‘RAM’) (156). The processing cores (164) are connected to RAM (156) through a high-speed memory bus (154) and through a bus adapter (194) and an extension bus (168) to other components of the compute node (152).

Stored in RAM (156) is a performance testing module (158), a module of computer program instructions that carries out parallel, user-level data processing using parallel algorithms. In particular, the performance testing module (158) of FIG. 2 operates for determining communications latency for transmissions between nodes in a data communications network according to embodiments of the present invention. The performance testing module (158) of FIG. 2 operates generally for determining communications latency for transmissions between nodes in a data communications network according to embodiments of the present invention by: preparing, by an origin node, to receive an acknowledgement message from a target node, the acknowledgement message indicating that the target node is ready to receive a test message from the origin node; receiving, by the origin node from the target node, the acknowledgement message; sending, by the origin node to the target node in response to receiving the acknowledgement message, the test message; preparing, by the origin node, to receive an echo message from the target node, the echo message indicating that the target node received the test message; receiving, by the origin node from the target node, the echo message; and determining, by the origin node, the round-trip communications latency between the origin node and the target node in dependence upon the sending of the test message and the receiving of the echo message. The performance testing module (158) of FIG. 2 may also operate generally for determining communications latency for transmissions between nodes in a data communications network according to embodiments of the present invention by: preparing, by the target node, to receive the test message from an origin node; sending, by the target node to the origin node, the acknowledgement message in response to preparing to receive the test message; receiving, by the target node from the origin node, the test message in response to sending the acknowledgement message; and sending, by the target node to the origin node in response to receiving the test message, the echo message.

Also stored in RAM (156) is a messaging module (160), a library of computer program instructions that carry out parallel communications among compute nodes, including point to point operations as well as collective operations. Performance testing module (158) executes point to point and collective operations by calling software routines in the messaging module (160). A library of parallel communications routines may be developed from scratch for use in systems according to embodiments of the present invention, using a traditional programming language such as the C programming language, and using traditional programming methods to write parallel communications routines that send and receive data among nodes on two independent data communications networks. Alternatively, existing prior art libraries may be improved to operate according to embodiments of the present invention. Examples of prior-art parallel communications libraries include the ‘Message Passing Interface’ (‘MPI’) library and the ‘Parallel Virtual Machine’ (‘PVM’) library.

Also stored in RAM (156) is an operating system (162), a module of computer program instructions and routines for an application program's access to other resources of the compute node. It is typical for an application program and parallel communications library in a compute node of a parallel computer to run a single thread of execution with no user login and no security issues because the thread is entitled to complete access to all resources of the node. The quantity and complexity of tasks to be performed by an operating system on a compute node in a parallel computer therefore are smaller and less complex than those of an operating system on a serial computer with many threads running simultaneously. In addition, there is no video I/O on the compute node (152) of FIG. 2, another factor that decreases the demands on the operating system. The operating system may therefore be quite lightweight by comparison with operating systems of general purpose computers, a pared down version as it were, or an operating system developed specifically for operations on a particular parallel computer. Operating systems that may usefully be improved, simplified, for use in a compute node include UNIX™, Linux™, Microsoft XP™, AIX™, IBM's i5/OS™, and others as will occur to those of skill in the art.

The exemplary compute node (152) of FIG. 2 includes several communications adapters (172, 176, 180, 188) for implementing data communications with other nodes of a parallel computer. Such data communications may be carried out serially through RS-232 connections, through external buses such as Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful in systems for determining communications latency for transmissions between nodes in a data communications network according to embodiments of the present invention include modems for wired communications, Ethernet (IEEE 802.3) adapters for wired network communications, and 802.11b adapters for wireless network communications.

The data communications adapters in the example of FIG. 2 include a Gigabit Ethernet adapter (172) that couples example compute node (152) for data communications to a Gigabit Ethernet (174). Gigabit Ethernet is a network transmission standard, defined in the IEEE 802.3 standard, that provides a data rate of 1 billion bits per second (one gigabit). Gigabit Ethernet is a variant of Ethernet that operates over multimode fiber optic cable, single mode fiber optic cable, or unshielded twisted pair.

The data communications adapters in the example of FIG. 2 includes a JTAG Slave circuit (176) that couples example compute node (152) for data communications to a JTAG Master circuit (178). JTAG is the usual name used for the IEEE 1149.1 standard entitled Standard Test Access Port and Boundary-Scan Architecture for test access ports used for testing printed circuit boards using boundary scan. JTAG is so widely adapted that, at this time, boundary scan is more or less synonymous with JTAG. JTAG is used not only for printed circuit boards, but also for conducting boundary scans of integrated circuits, and is also useful as a mechanism for debugging embedded systems, providing a convenient “back door” into the system. The example compute node of FIG. 2 may be all three of these: It typically includes one or more integrated circuits installed on a printed circuit board and may be implemented as an embedded system having its own processor, its own memory, and its own I/O capability. JTAG boundary scans through JTAG Slave (176) may efficiently configure processor registers and memory in compute node (152) for use in determining communications latency for transmissions between nodes in a data communications network according to embodiments of the present invention.

The data communications adapters in the example of FIG. 2 includes a Point To Point Adapter (180) that couples example compute node (152) for data communications to a network (108) that is optimal for point to point message passing operations such as, for example, a network configured as a three-dimensional torus or mesh. Point To Point Adapter (180) provides data communications in six directions on three communications axes, x, y, and z, through six bidirectional links: +x (181), −x (182), +y (183), −y (184), +z (185), and −z (186).

The data communications adapters in the example of FIG. 2 includes a Global Combining Network Adapter (188) that couples example compute node (152) for data communications to a network (106) that is optimal for collective message passing operations on a global combining network configured, for example, as a binary tree. The Global Combining Network Adapter (188) provides data communications through three bidirectional links: two to children nodes (190) and one to a parent node (192).

Example compute node (152) includes two arithmetic logic units (‘ALUs’). ALU (166) is a component of each processing core (164), and a separate ALU (170) is dedicated to the exclusive use of Global Combining Network Adapter (188) for use in performing the arithmetic and logical functions of reduction operations. Computer program instructions of a reduction routine in parallel communications library (160) may latch an instruction for an arithmetic or logical function into instruction register (169). When the arithmetic or logical function of a reduction operation is a ‘sum’ or a ‘logical or,’ for example, Global Combining Network Adapter (188) may execute the arithmetic or logical operation by use of ALU (166) in processor (164) or, typically much faster, by use dedicated ALU (170).

The example compute node (152) of FIG. 2 includes a direct memory access (‘DMA’) controller (195), which is computer hardware for direct memory access and a DMA engine (197), which is computer software for direct memory access. In the example of FIG. 2, the DMA engine (197) is configured in computer memory of the DMA controller (195). Direct memory access includes reading and writing to memory of compute nodes with reduced operational burden on the central processing units (164). A DMA transfer essentially copies a block of memory from one location to another, typically from one compute node to another. While the CPU may initiate the DMA transfer, the CPU does not execute it.

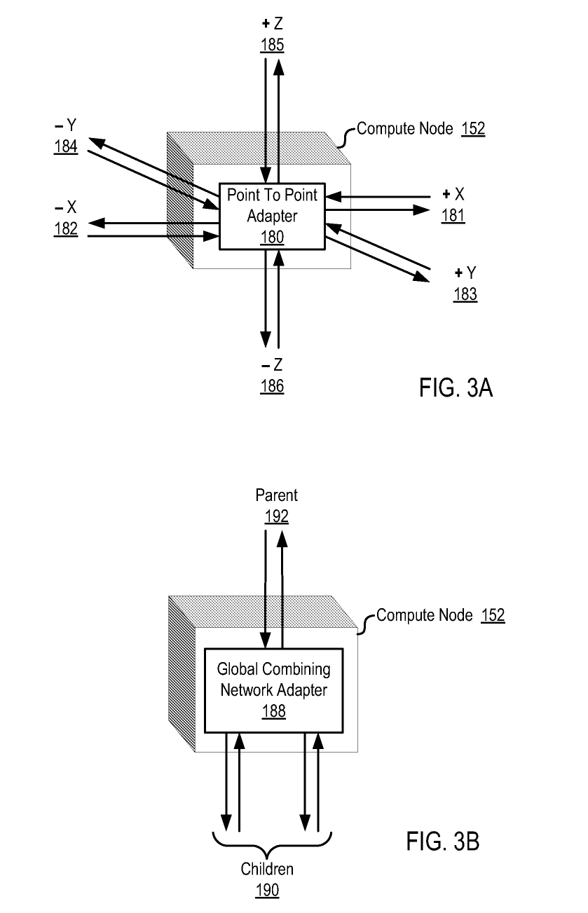

For further explanation, FIG. 3A illustrates an exemplary Point To Point Adapter (180) useful in a parallel computer capable of determining communications latency for transmissions between nodes in a data communications network according to embodiments of the present invention. Point To Point Adapter (180) is designed for use in a data communications network optimized for point to point operations, a network that organizes compute nodes in a three-dimensional torus or mesh. Point To Point Adapter (180) in the example of FIG. 3A provides data communication along an x-axis through four unidirectional data communications links, to and from the next node in the −x direction (182) and to and from the next node in the +x direction (181). Point To Point Adapter (180) also provides data communication along a y-axis through four unidirectional data communications links, to and from the next node in the −y direction (184) and to and from the next node in the +y direction (183). Point To Point Adapter (180) in FIG. 3A also provides data communication along a z-axis through four unidirectional data communications links, to and from the next node in the −z direction (186) and to and from the next node in the +z direction (185).

For further explanation, FIG. 3B illustrates an exemplary Global Combining Network Adapter (188) useful in a parallel computer capable of determining communications latency for transmissions between nodes in a data communications network according to embodiments of the present invention. Global Combining Network Adapter (188) is designed for use in a network optimized for collective operations, a network that organizes compute nodes of a parallel computer in a binary tree. Global Combining Network Adapter (188) in the example of FIG. 3B provides data communication to and from two children nodes (190) through two links. Each link to each child node (190) is formed from two unidirectional data communications paths. Global Combining Network Adapter (188) also provides data communication to and from a parent node (192) through a link form from two unidirectional data communications paths.

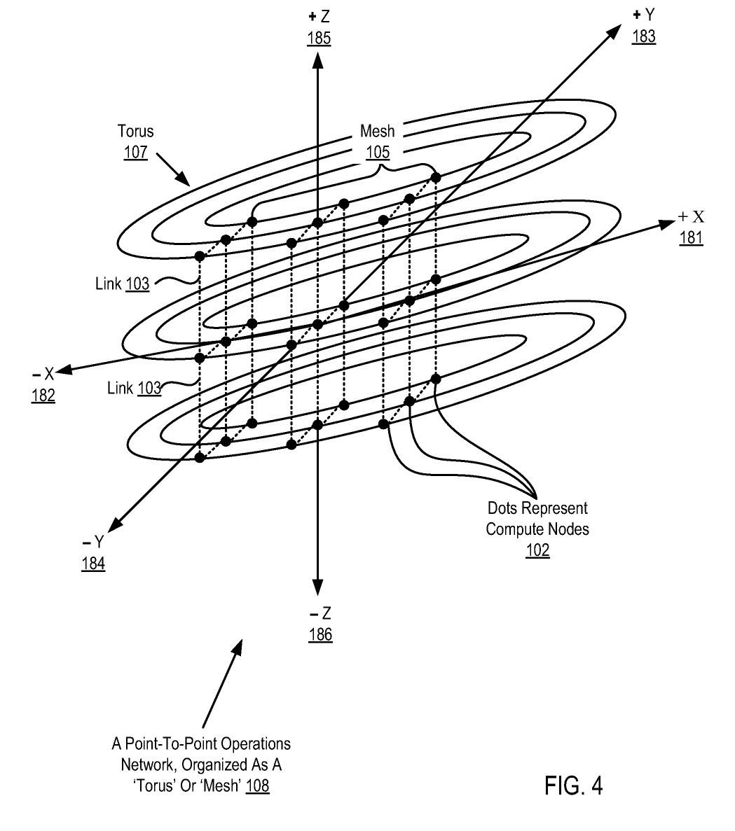

For further explanation, FIG. 4 sets forth a line drawing illustrating an exemplary data communications network (108) optimized for point to point operations useful in a parallel computer capable of determining communications latency for transmissions between nodes in a data communications network in accordance with embodiments of the present invention. In the example of FIG. 4, dots represent compute nodes (102) of a parallel computer, and the dotted lines between the dots represent data communications links (103) between compute nodes. The data communications links are implemented with point to point data communications adapters similar to the one illustrated for example in FIG. 3A, with data communications links on three axes, x, y, and z, and to and from in six directions +x (181), −x (182), +y (183), −y (184), +z (185), and −z (186). The links and compute nodes are organized by this data communications network optimized for point to point operations into a three dimensional mesh (105). The mesh (105) has wrap-around links on each axis that connect the outermost compute nodes in the mesh (105) on opposite sides of the mesh (105). These wrap-around links form part of a torus (107). Each compute node in the torus has a location in the torus that is uniquely specified by a set of x, y, z coordinates. Readers will note that the wrap-around links in the y and z directions have been omitted for clarity, but are configured in a similar manner to the wrap-around link illustrated in the x direction. For clarity of explanation, the data communications network of FIG. 4 is illustrated with only 27 compute nodes, but readers will recognize that a data communications network optimized for point to point operations for use in determining communications latency for transmissions between nodes in a data communications network in accordance with embodiments of the present invention may contain only a few compute nodes or may contain thousands of compute nodes.

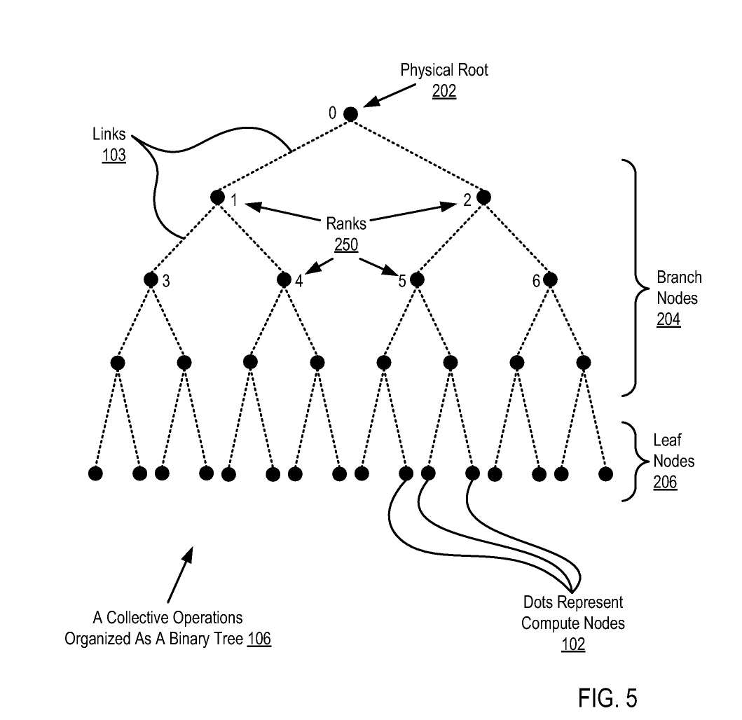

For further explanation, FIG. 5 sets forth a line drawing illustrating an exemplary data communications network (106) optimized for collective operations useful in a parallel computer capable of determining communications latency for transmissions between nodes in a data communications network in accordance with embodiments of the present invention. The example data communications network of FIG. 5 includes data communications links connected to the compute nodes so as to organize the compute nodes as a tree. In the example of FIG. 5, dots represent compute nodes (102) of a parallel computer, and the dotted lines (103) between the dots represent data communications links between compute nodes. The data communications links are implemented with global combining network adapters similar to the one illustrated for example in FIG. 3B, with each node typically providing data communications to and from two children nodes and data communications to and from a parent node, with some exceptions. Nodes in a binary tree (106) may be characterized as a physical root node (202), branch nodes (204), and leaf nodes (206). The root node (202) has two children but no parent. The leaf nodes (206) each has a parent, but leaf nodes have no children. The branch nodes (204) each has both a parent and two children. The links and compute nodes are thereby organized by this data communications network optimized for collective operations into a binary tree (106). For clarity of explanation, the data communications network of FIG. 5 is illustrated with only 31 compute nodes, but readers will recognize that a data communications network optimized for collective operations for use in a parallel computer for determining communications latency for transmissions between nodes in a data communications network accordance with embodiments of the present invention may contain only a few compute nodes or may contain thousands of compute nodes.

In the example of FIG. 5, each node in the tree is assigned a unit identifier referred to as a ‘rank’ (250). A node's rank uniquely identifies the node's location in the tree network for use in both point to point and collective operations in the tree network. The ranks in this example are assigned as integers beginning with 0 assigned to the root node (202), 1 assigned to the first node in the second layer of the tree, 2 assigned to the second node in the second layer of the tree, 3 assigned to the first node in the third layer of the tree, 4 assigned to the second node in the third layer of the tree, and so on. For ease of illustration, only the ranks of the first three layers of the tree are shown here, but all compute nodes in the tree network are assigned a unique rank.

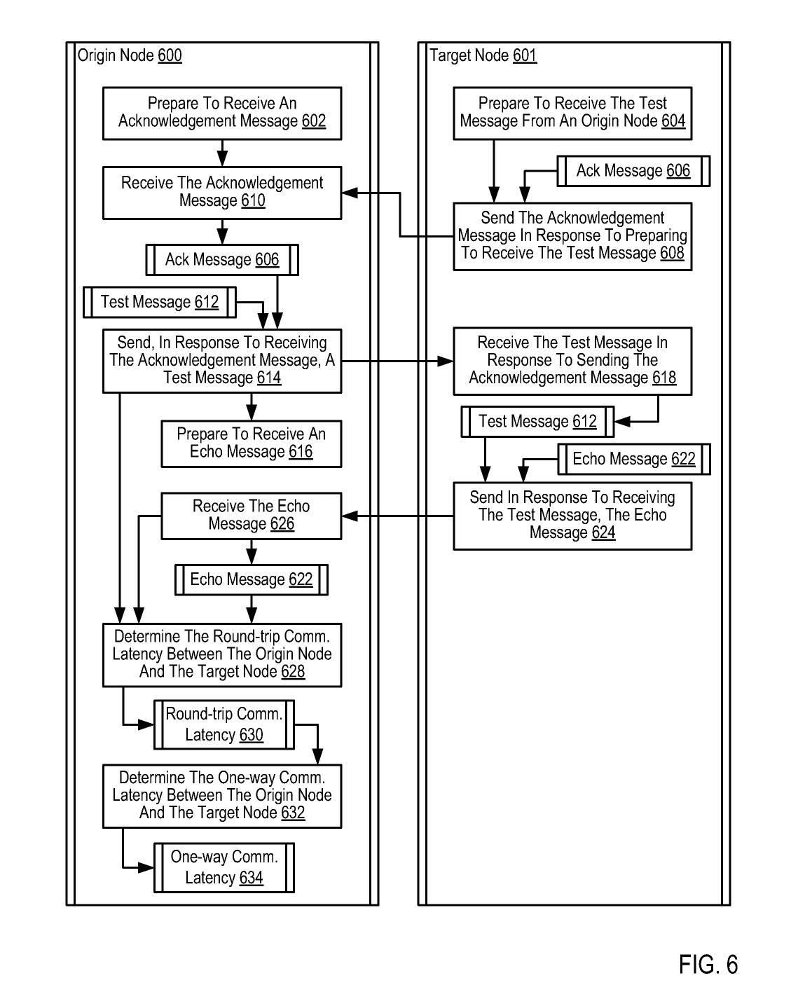

FIG. 6 sets forth a flow chart illustrating an exemplary method for determining communications latency for transmissions between nodes in a data communications network according to the present invention. The method of FIG. 6 includes preparing (602), by an origin node (600), to receive an acknowledgement message (606) from a target node (601). The acknowledgement message (606) of FIG. 6 represents a message indicating that the target node (601) is ready to receive a test message (612) from the origin node (600). The origin node (600) may prepare (602) to receive the acknowledgement message (606) from the target node (601) according to the method of FIG. 6 by allocating computer memory on the origin node (600) for storing the acknowledgement message (606) and monitoring a reception buffer that stores messages received through the network for the acknowledgement message (606).

The method of FIG. 6 also includes preparing (604), by the target node (601), to receive the test message (612) from the origin node (600). The test message (601) of FIG. 6 represents a message whose travel time from the origin compute node (600) to the target compute node (601) through the network is used to determining the communications latency between the origin node (600) and the target node (601). The test message (601) of FIG. 6 may contain any kind of data or be of any size as will occur to those of skill in the art. The target node (601) may prepare (604) to receive the test message (612) from the origin node (600) according to the method of FIG. 6 by allocating computer memory on the target node (601) for storing the test message (612) and monitoring a reception buffer that stores messages received through the network for the test message (612).

The method of FIG. 6 includes sending (608), by the target node (601) to the origin node (600), the acknowledgement message (606) in response to preparing to receive the test message (612). The target compute node (601) may send (608) the acknowledgement message (606) to the origin node (600) according to the method of FIG. 6 by packetizing the acknowledgement message (606) into a network packet that specifies the origin node (600) as the packet destination and injecting the network packet into a transmission stack of the network adapter on the target node (601) for transmission through the network.

The method of FIG. 6 also includes receiving (610), by the origin node (600) from the target node (601), the acknowledgement message (606). The origin node (600) may receive (610) the acknowledgement message (606) from the target node (601) according to the method of FIG. 6 by retrieving a network packet from the reception stack of the origin node's network adapter into the origin node's reception buffer, unencapsulating the acknowledgement message (606) from the network packet, and storing the acknowledgement message (606) in computer memory previously allocated for the message (606).

The method of FIG. 6 includes sending (614), by the origin node (600) to the target node (601) in response to receiving the acknowledgement message (606), the test message (612). The origin node (600) may send (614) the test message (612) to the target node (601) according to the method of FIG. 6 by packetizing the test message (612) into a network packet that specifies the target node (601) as the packet destination and injecting the network packet into a transmission stack of the network adapter on the origin node (600) for transmission through the network. In the method of FIG. 6, sending (614) the test message (612) in response to receiving the acknowledgement message (606) advantageously ensures that the target node (600) is ready to process the test message (612) as soon as the target node receives the message (612). In such a manner, accurate determination of communications latency is furthered.

The method of FIG. 6 also includes preparing (616), by the origin node (600), to receive an echo message (622) from the target node (601). The echo message (622) of FIG. 6 represents a message indicating that the target node (601) received the test message (612). In many embodiments, the test message (612) and the echo message (622) may be the same size, or even the same message. The origin node (600) may prepare (616) to receive an echo message (622) from the target node (601) according to the method of FIG. 6 by allocating computer memory on the origin node (601) for storing the echo message (622) and monitoring a reception buffer that stores messages received through the network for the echo message (622).

The method of FIG. 6 includes receiving (618), by the target node (601) from the origin node (600), the test message (612) in response to sending the acknowledgement message (606). The target node (601) may receive (618) the test message (612) according to the method of FIG. 6 by retrieving a network packet from the reception stack of the origin node's network adapter into the origin node's reception buffer, unencapsulating the test message (612) from the network packet, and storing the test message (612) in computer memory previously allocated for the message (612).

The method of FIG. 6 also includes sending (624), by the target node (601) to the origin node (600) in response to receiving the test message (612), the echo message (622). The target node (601) may send (624) the echo message (622) to the origin node (600) according to the method of FIG. 6 by packetizing the echo message (622) into a network packet that specifies the origin node (600) as the packet destination and injecting the network packet into a transmission stack of the network adapter on the target node (601) for transmission through the network.

The method of FIG. 6 includes receiving (626), by the origin node (600) from the target node (601), the echo message (622). The origin node (600) may receive (626) the echo message (622) the from the target node (601) according to the method of FIG. 6 by retrieving a network packet from the reception stack of the origin node's network adapter into the origin node's reception buffer, unencapsulating the echo message (622) from the network packet, and storing the echo message (622) in computer memory previously allocated for the message (622).

The method of FIG. 6 includes determining (628), by the origin node (600), the round-trip communications latency (630) between the origin node (600) and the target node (601) in dependence upon the sending (614) of the test message (614) and the receiving (626) of the echo message (622). The round-trip communications latency (630) of FIG. 6 represents the total time required for a message to move through a network from the origin node (600) to the target node (601) and then return through the network to the origin node (600). The origin node (600) may determine (628) the round-trip communications latency (630) between the origin node (600) and the target node (601) according to the method of FIG. 6 by capturing a start time when the test message (614) is sent (614), capturing an end time when the echo message (622) is received (626), and setting the difference between the end time and the start time as the round-trip communications latency (630). For example, consider that the start time captured when the test message (614) is sent (614) is ‘53411.231749 seconds’ and that the end time captured when the echo message (622) is received (626) is ‘53411.232937 seconds.’ The round-trip communications latency (630) between the origin node (600) and the target node (601) may be set as follows:

$$\begin{matrix}{L}_{RT} = {T}_{ET} - {T}_{ST} \\ = 53411.232937 seconds - 53411.231749 seconds \\ = 0.001188 seconds or 1.188 milliseconds\end{matrix}$$

where ‘L_{RT}’ is the round-trip communications latency, ‘T_{ET}’ is the end time captured when the echo message is received, and ‘T_{ST}’ is the start time captured when the test message is sent.

The method of FIG. 6 also includes determining (632), by the origin node (600), the one-way communications latency (634) between the origin node (600) and the target node (601). The one-way communications latency (634) of FIG. 6 represents the time required for a message to move through a network from the origin node (600) to the target node (601). The origin node (600) may determine (632) the one-way communications latency (634) according to the method of FIG. 6 by dividing the round-trip communications latency (630) by two. Continuing with the example from above, the one-way communications latency may be determined as follows:

$$\begin{matrix}{L}_{OW} = {L}_{RT} \div 2 \\ = 1.188 milliseconds \div 2 \\ = 0.594 milliseconds\end{matrix}$$

where ‘L_{OW}’ is the one-way communications latency and ‘L_{RT}’ is the round-trip communications latency.

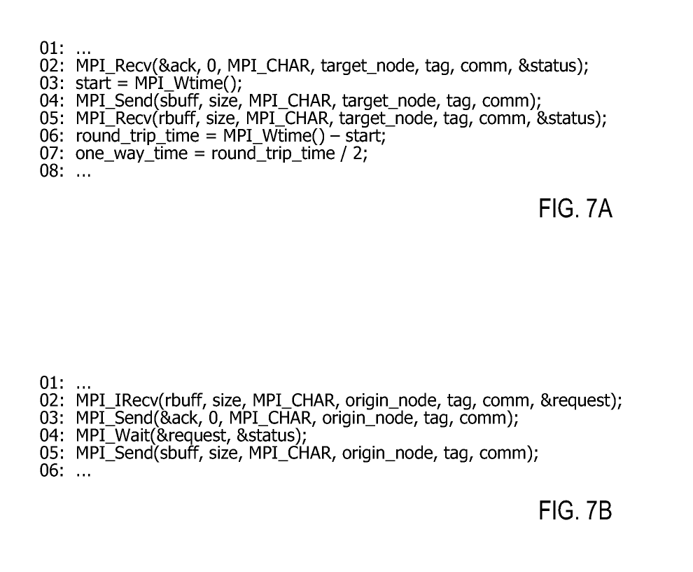

For further explanation, FIGS. 7A and 7B sets forth an exemplary listing of pseudo-code that describes determining communications latency for transmissions between nodes in a data communications network according to embodiments of the present invention using message passing operations described in the MPI family of specifications. The exemplary pseudo-code of FIG. 7A describes determining communications latency for transmissions between nodes in a data communications network according to embodiments of the present invention from the perspective of an origin node. The exemplary pseudo-code of FIG. 7B describes determining communications latency for transmissions between nodes in a data communications network according to embodiments of the present invention from the perspective of a target node.

FIG. 7A illustrates pseudo-code instructing the origin node to prepare to receive an acknowledgement message and to receive the acknowledgement message from the target node in line 02. The pseudo-code in line 02 is implemented using an ‘MPI_Recv’ operation. Because the ‘MPI_Recv’ operation is a blocking operation, the origin node does not move past line 02 in the algorithm described in FIG. 7A until the origin node receives the acknowledgement message from the target node. Exemplary pseudo-code that instructs the target node to send an acknowledgement message to the origin node is described below.

Turning now to the target node, line 02 of FIG. 7B illustrates pseudo-code instructing the target node to prepare to receive a test message from the origin node. The pseudo-code in line 02 is implemented using an ‘MPI_IRecv’ operation. Because the ‘MPI_IRecv’ operation is a non-blocking operation, the target node proceeds past line 02 in the algorithm described in FIG. 7B. That is, the target node processes the instructions of line 02 in FIG. 7B and proceeds to line 03.

Line 03 of FIG. 7B illustrates pseudo-code instructing the target node to send the acknowledgement message to the origin node. The pseudo-code in line 03 is implemented using an ‘MPI_Send’ operation, a blocking operation that is paired with the ‘MPI_Recv’ operation in line 02 of FIG. 7A. That is, after the target node completes the ‘MPI_Send’ operation in line 03 of FIG. 7B, the origin node may return from the ‘MPI_Recv’ operation in line 02 of FIG. 7A. After the target node processes the ‘MPI_Recv’ operation in line 03 of FIG. 7B, line 04 of FIG. 7B instructs the target node to wait for the non-blocking ‘MPI_IRecv’ operation to complete using the ‘MPI_Wait’ operation in line 04. The non-blocking ‘MPI_IRecv’ operation completes when the target node receives the test message from the origin node.

After origin node returns from the ‘MPI_Recv’ operation in line 02 of FIG. 7A, the origin node then proceeds to line 03 of FIG. 7A. Line 03 of FIG. 7A illustrates pseudo-code used in the determination of the round-trip communications latency between the origin node and the target node. The ‘start=MPI_Wtime( )’ command of line 03 of FIG. 7A instructs the origin node to capture a start time for sending a test message from the origin node to the target node.

Line 04 of FIG. 7A illustrates pseudo-code that instructs the origin node to send the test message to the target node using the ‘MPI_Send’ command, a blocking operation that is paired with the ‘MPI_Recv’ operation in line 02 of FIG. 7B. After the origin node processes the ‘MPI_Send’ operation in line 04 of FIG. 7A, line 05 of FIG. 7A instructs the origin node to prepare to receive an echo message from the target node using the ‘MPI_Recv’ operation. Also, upon the origin node's completion of the ‘MPI_Send’ operation in line 04 of FIG. 7A, the target node may complete the ‘MPI_IRecv’ operation in line 02 of FIG. 7B that instructs the target node to receive the test message from the origin node and return from the ‘MPI_Wait’ operation in line 04.

Line 05 of FIG. 7B illustrates pseudo-code that then instructs the target node to send the echo message to the origin node using the ‘MPI_Send’ operation, a blocking operation that is paired with the ‘MPI_Recv’ operation in line 05 of FIG. 7A. That is, upon the target node's completion of the ‘MPI_Send’ operation in line 05 of FIG. 7B, the origin node may complete the ‘MPI_Recv’ operation in line 05 of FIG. 7A that instructs the origin node to receive the echo message from the target node.

Line 06 of FIG. 7A illustrates pseudo-code used in the determination of the round-trip communications latency between the origin node and the target node. The ‘round_trip_time=MPI_Wtime( )−start’ command of line 06 of FIG. 7A instructs the origin node to capture an end time at which the echo message was received and set the round-trip communications latency as the difference between the captured end time and the captured start time. Line 07 of FIG. 7A illustrates pseudo-code used in the determination of the one-way communications latency between the origin node and the target node. The ‘one_way_time=round_trip_time/2’ command of line 07 in FIG. 7A instructs the origin node to set the one-way communications latency as the round-trip communications latency divided by two.

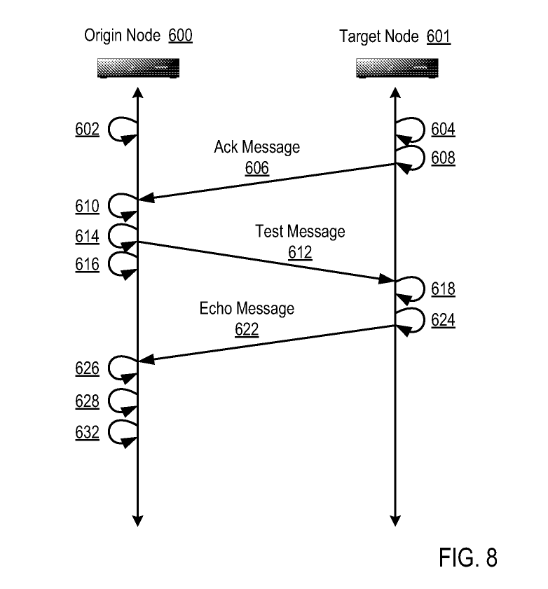

For further explanation, FIG. 8 sets forth a call sequence diagram illustrating an exemplary call sequence for determining communications latency for transmissions between nodes in a data communications network according to embodiments of the present invention. In the exemplary call sequence diagram of FIG. 8, the origin node (600) prepares (602) to receive an acknowledgement message (606) from a target node (601). The acknowledgement message (606) indicates that the target node (601) is ready to receive a test message (612) from the origin node (600).

Similarly, in the exemplary call sequence diagram of FIG. 8, the target node (601) prepares (604) to receive the test message (612) from the origin node (600). In response to preparing to receive the test message (612), the target node (601) also sends (608) the acknowledgement message (606) to the origin node (600).

The origin node (600) of FIG. 8 receives (610) the acknowledgement message (606) from the target node (601). In response to receiving the acknowledgement message (606), the origin node (600) sends (614) the test message (612) to the target node (601). The origin node (600) prepares (616) to receive an echo message (622) from the target node (601). The echo message (622) indicates that the target node (601) received the test message.

In the exemplary call sequence diagram of FIG. 8, the target node (601) receives (618) the test message (612) in response to the sending the acknowledgement message (606). The target node (601) then sends (624) the echo message (622) to the origin node (600) in response to receiving the test message (612).

The origin node (600) of FIG. 8 receives (626) the echo message (622) from the target node (601). The origin node (600) of FIG. 8 then determines (628) the round-trip communications latency between the origin node (600) and the target node (601) in dependence upon the sending (614) of the test message (612) and the receiving (626) of the echo message (622). The origin node (600) of FIG. 8 also determines (632) the one-way communications latency between the origin node (600) and the target node (601), including dividing the round-trip communications latency by two.

Exemplary embodiments of the present invention are described largely in the context of a fully functional parallel computer system for determining communications latency for transmissions between nodes in a data communications network. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for determining communications latency for transmissions between nodes in a data communications network, the method comprising:
preparing, by an origin node, to receive an acknowledgement message from a target node, the acknowledgement message indicating that the target node is ready to receive a test message from the origin node;
receiving, by the origin node from the target node, the acknowledgement message;
sending, by the origin node to the target node in response to receiving the acknowledgement message, the test message;
preparing, by the origin node, to receive an echo message from the target node, the echo message indicating that the target node received the test message;
receiving, by the origin node from the target node, the echo message; and
determining, by the origin node, a round-trip communications latency between the origin node and the target node in dependence upon the sending of the test message and the receiving of the echo message.

2. The method of claim 1 further comprising determining, by the origin node, a one-way communications latency between the origin node and the target node, including dividing the round-trip communications latency by two.

3. The method of claim 1 further comprising:
preparing, by the target node, to receive the test message from the origin node;
sending, by the target node to the origin node, the acknowledgement message in response to preparing to receive the test message;
receiving, by the target node from the origin node, the test message in response to sending the acknowledgement message; and
sending, by the target node to the origin node in response to receiving the test message, the echo message.

4. The method of claim 1 wherein the test message and the echo message are the same size.

5. The method of claim 1 wherein the origin node and the target node are compute nodes comprised in a parallel computer, the parallel computer comprising a plurality of compute nodes connected for data communications through a plurality of data communications networks, at least one of the data communications networks optimized for point to point data communications, and at least one of the data communications networks optimized for collective operations.

6. The method of claim 5 wherein the plurality of compute nodes are partitioned into a plurality of processing sets, each processing set comprising an input/output node connected for data communications to the compute nodes for that processing set.

7. A system for determining communications latency for transmissions between nodes in a data communications network, the system comprising an origin node and a target node, the origin node comprising an origin computer processor and origin computer memory operatively coupled to the origin computer processor, the origin computer memory having disposed within it computer program instructions capable of:
preparing to receive an acknowledgement message from a target node, the acknowledgement message indicating that the target node is ready to receive a test message from the origin node;
receiving, from the target node, the acknowledgement message;
sending, to the target node in response to receiving the acknowledgement message, the test message;
preparing to receive an echo message from the target node, the echo message indicating that the target node received the test message;
receiving, from the target node, the echo message; and
determining a round-trip communications latency between the origin node and the target node in dependence upon the sending of the test message and the receiving of the echo message.

8. The system of claim 8 wherein the origin computer memory also has disposed within it computer program instructions capable of determining a one-way communications latency between the origin node and the target node, including dividing the round-trip communications latency by two.

9. The system of claim 8 wherein the target node further comprises a target computer processor and target computer memory operatively coupled to the target computer processor, the target computer memory having disposed within it computer program instructions capable of:
preparing to receive the test message from the origin node;
sending, to the origin node, the acknowledgement message in response to preparing to receive the test message;
receiving, from the origin node, the test message in response to sending the acknowledgement message; and
sending, to the origin node in response to receiving the test message, the echo message.

10. The system of claim 8 wherein the test message and the echo message are the same size.

11. The system of claim 8 wherein the origin node and the target node are compute nodes comprised in a parallel computer, the parallel computer comprising a plurality of compute nodes connected for data communications through a plurality of data communications networks, at least one of the data communications networks optimized for point to point data communications, and at least one of the data communications networks optimized for collective operations.

12. The system of claim 11 wherein the plurality of compute nodes are partitioned into a plurality of processing sets, each processing set comprising an input/output node connected for data communications to the compute nodes for that processing set.

13. A computer program product for determining communications latency for transmissions between nodes in a data communications network, the computer program product disposed upon a computer readable medium, the computer program product comprising computer program instructions capable of:
preparing, by an origin node, to receive an acknowledgement message from a target node, the acknowledgement message indicating that the target node is ready to receive a test message from the origin node;
receiving, by the origin node from the target node, the acknowledgement message;
sending, by the origin node to the target node in response to receiving the acknowledgement message, the test message;
preparing, by the origin node, to receive an echo message from the target node, the echo message indicating that the target node received the test message;
receiving, by the origin node from the target node, the echo message; and
determining, by the origin node, a round-trip communications latency between the origin node and the target node in dependence upon the sending of the test message and the receiving of the echo message.

14. The computer program product of claim 13 further comprising computer program instructions capable of determining, by the origin node, a one-way communications latency between the origin node and the target node, including dividing the round-trip communications latency by two.

15. The computer program product of claim 13 further comprising computer program instructions capable of:
preparing, by the target node, to receive the test message from the origin node;
sending, by the target node to the origin node, the acknowledgement message in response to preparing to receive the test message;
receiving, by the target node from the origin node, the test message in response to sending the acknowledgement message; and
sending, by the target node to the origin node in response to receiving the test message, the echo message.

16. The computer program product of claim 13 wherein the test message and the echo message are the same size.

17. The computer program product of claim 13 wherein the origin node and the target node are compute nodes comprised in a parallel computer, the parallel computer comprising a plurality of compute nodes connected for data communications through a plurality of data communications networks, at least one of the data communications networks optimized for point to point data communications, and at least one of the data communications networks optimized for collective operations.

18. The computer program product of claim 17 wherein the plurality of compute nodes are partitioned into a plurality of processing sets, each processing set comprising an input/output node connected for data communications to the compute nodes for that processing set.

19. The computer program product of claim 13 wherein the computer readable medium comprises a recordable medium.

20. The computer program product of claim 13 wherein the computer readable medium comprises a transmission medium.
